(19) United States
(12) Patent Application Publication
(10) Pub. No.: US 2010/0300818 A1
(43) Pub. Date: Dec. 2, 2010

(54) Shaft Holding System for Cryogenic Pumps or Expanders

(75) Inventor: Keijun Kamio, Sparks, NV (US)

Correspondence Address: SILVERSKY GROUP LLC, 5422 LONGLEY LANE, SUITE B, RENO, NV, 89511, US

(73) Assignee: EBARA INTERNATIONAL CORPORATION, Sparks, NV (US)

(21) Appl. No.: 12/788,215

(22) Filed: May 26, 2010

Related U.S. Application Data
(60) Provisional application No. 61/217,201, filed on May 26, 2009.

(51) Int. Cl. F16D 65/32

(52) U.S. Cl. 188/151 R

(57) ABSTRACT

A shaft holding system for cryogenic pumps or expanders comprising of a set of hydraulic brakes surrounding the shaft of turbomachinery. Fluid or gas is introduced into the bellows chamber of a brake assembly. The bellows chamber expands due to the increase in pressure, thus exerting a force on the piston of the brake assembly. The piston in turn exerts a force on a brake rod, which pushes a brake pad attached to the end of the brake rod against the shaft. A feed line supplies fluid or gas to the hydraulics of the brake assembly. Two or more brakes can be used to secure the shaft of the turbomachine. A turbomachine including more than one shaft can use a set of brakes for each shaft of the turbomachine.

### CROSS-REFERENCES TO RELATED APPLICATIONS

This application claims priority from provisional patent application Ser. No. 61/217,201, filed May 26, 2009, which is hereby incorporated herein by reference in its entirety to be considered part of this specification.

### BRIEF DESCRIPTION OF THE INVENTION

A shaft holding system for cryogenic pumps or expanders comprising a set of hydraulic brakes surrounding the shaft of a turbomachine. Fluid or gas is introduced into the bellows chamber of a brake assembly. The bellows chamber expands due to the increase in pressure, thus exerting a force on the piston of the brake assembly. The piston in turn exerts a force on a brake rod, which pushes a brake pad attached to the end of the brake rod against the shaft. A feed line supplies fluid or gas to the hydraulics of the brake assembly. Two or more brakes can be used to secure the shaft of the turbomachine. A turbomachine including more than one shaft can use a set of brakes for each shaft of the turbomachine.

### STATEMENTS AS TO THE RIGHTS TO INVENTIONS MADE UNDER FEDERALLY SPONSORED RESEARCH OR DEVELOPMENT

Not applicable.

### REFERENCE TO A “SEQUENCE LISTING,” A TABLE, OR A COMPUTER PROGRAM LISTING APPENDIX SUBMITTED ON A COMPACT DISK.

Not applicable.

### BACKGROUND OF THE INVENTION

Cryogenic liquids are refrigerated liquefied gases with boiling points below −90° C. at atmospheric pressure. Different cryogens become liquids under different conditions of temperature and pressure. Industrial facilities that produce, store, transport and utilize such gases make use of a variety of valves, pumps and expanders to move, control and process the liquids and gases.

There are problems which can damage a shaft of an expander or a pump during standstill conditions. For example, reverse flow can force the shaft to rotate in reverse, potentially damaging the shaft and introducing stress to the shaft bearings. An unstable foundation can also make the shaft of an expander or a pump rotate. Movement in floating platforms can cause the pump or expander to move around, which can cause the shaft of the pump or expander to get damaged. In floating storage and regasification units that are permanently moored offshore, weather conditions can result in significant movement due to ocean conditions. For example, if a ship motion constantly changes by pitching and rolling, this can make an expander or pump installed in a vessel, or on a floating storage tank, receive continuous side forces that can damage the shaft.

### BRIEF DESCRIPTION OF THE SEVERAL VIEWS OF THE DRAWING

FIG. 1 is a cross-sectional view of a brake assembly in accordance with an embodiment;

FIGS. 2A and 2B illustrate a cross-sectional, detailed view of the brake assembly from FIG. 1; and

FIGS. 3A and 3B illustrate a partially broken, cross-sectional view of a turbomachine with two brakes holding a shaft of the turbomachine in accordance with an embodiment.

### DETAILED DESCRIPTION OF THE INVENTION

A shaft holding system consisting of two or more brake assemblies surrounding the shaft of turbomachinery. Turbomachinery generally refers to machines that transfer energy from the processing of a fluid or gas using some type of turbine. From herein, the terms “turbomachinery” and “turbomachines” will be used to refer to turbines, expanders, compressors, fans, or pumps.

Each brake assembly consists of one or more hydraulic brakes. In operation, pressure is introduced into a bellows chamber of the brake, which exerts force on a piston. The piston applies force to a brake pad, which forces the brake pads to be pushed against the shaft of the expander, the pump, or other structure. Face seals are used to prevent pressure from escaping around the piston.

Turbomachines with two or more shafts can use a set of brakes for each of the two or more shafts. For example, in a turbine with a first shaft and a second shaft, where torque from the first shaft is transferred to the second shaft via a magnetically coupled membrane, a first set of brakes can be used for the first shaft and a second set of brakes can be used for the second shaft. Alternative embodiments can also include more than one set of brakes for each shaft. For example, a first set of brakes can be used on the top portion of a turbine shaft, and a second set of brakes can be used for the bottom portion of the turbine shaft.

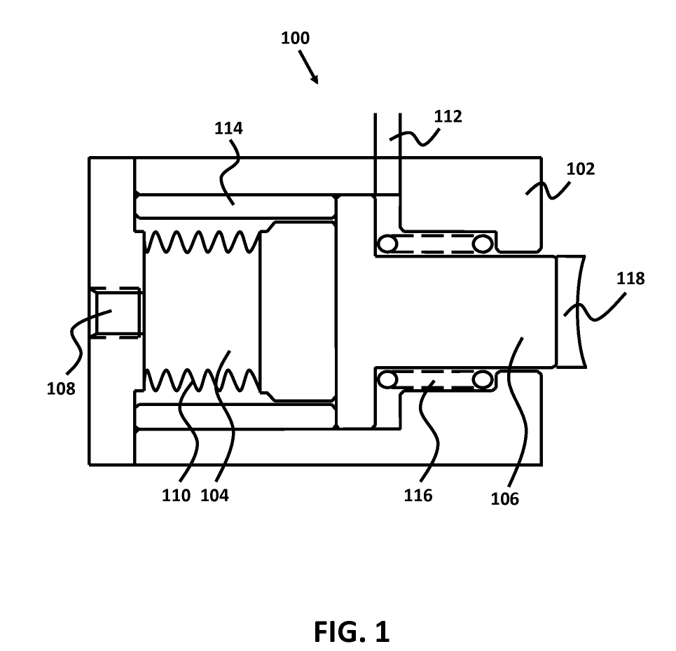

FIG. 1 illustrates a brake assembly 100 in accordance with an embodiment. The brake assembly consists of a brake body 102 encasing a bellows chamber 104 and a piston 106. Pressurized gas or liquid enters the bellows chamber 104 through inlet 108. The pressurized gas or liquid can be a mostly inert gas or liquid, such as nitrogen gas. The bellows chamber 104 expands as a result of the gas or fluid fed into the bellows chamber 104 forcing the piston 106 to move. The bellows chamber 104 includes a flexible conduit 110 that is seal welded to seal the high pressure of the bellows chamber 104. The piston travel, illustrated by the two lines 112, is restricted by a sleeve or piston stop 114 and resisted by a bias spring 116 surrounding the piston 106, which biases the piston 106 away from a shaft of a turbomachine (not shown). The end of the piston 106 includes a brake pad 118 that engages the shaft by being pushed against the shaft. Keeping the shaft from rotating is desirable in order to prevent damage to the bearings. When gas or fluid is bled from the bellows chamber 104, the bias spring 116 acts to pull the piston away from the shaft. Alternative embodiments may consist of a spring that biases the piston toward the shaft of the turbomachine and a bellows chamber 104 that pushes the piston away from the shaft when pressure is increased within the bellows chamber.

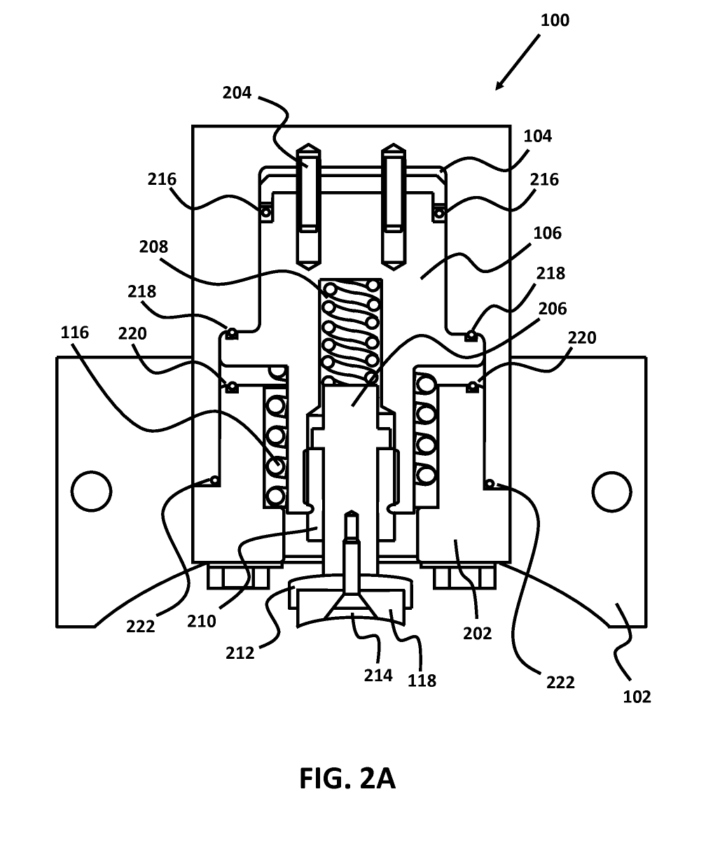

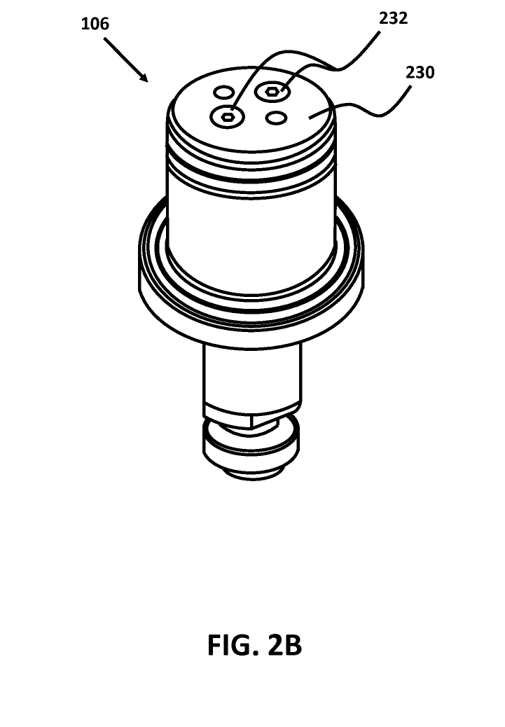

FIG. 2A illustrates a cross-sectional, detailed view of the brake assembly 100 from FIG. 1. The brake body 102 is further comprised of a brake plate 202. A pair of pins or dowels 204 control travel of the piston 106 within the brake body 102. The various parts of the brake assembly can be made from metal, such as steel or stainless steel. Embodiments of the brake body 102 can be made from stainless steel with an SAE grade of 304. Stainless steel of grade 304 consists of a composition of about 18% chromium and about 10% nickel. The brake plate 202 can be made with stainless steel with a composition of about 18% chromium and about 8% nickel. However, alternative embodiments may use different metals with different compositions based on the process requirements.

The brake piston 106 can similarly be made from stainless steel or other metals. The brake piston 106 exerts a force on a brake rod 206 via a central spring 208. A brake stop 210 prevents the brake rod 206 from fully extending under the expansion pressure of the central spring 208, thus restricting the piston travel. The brake rod 206, with the central spring 208, allow for pressure to be applied on the various face seals (further described below) of the brake assembly 100 and on the shaft (not shown) of the turbomachine. As previously noted, the bias spring 116 exerts pressure against the piston 106 in a direction opposite the shaft such that when pressure is removed from the bellows 104, the piston is retracted from contact with the shaft.

The brake pad 118 is attached via a support disk 212 to the brake rod 206. A screw cap 214 is used to attach the brake pad 118 to the piston 106. The brake pad 118 can be made out of Polytetrafluoroethylene (PTFE). The support disk 212 and the screw cap 214 can be made out of metal, such as stainless steel.

A pressure seal 216 seals the pressure inside of the piston 106. The pressure seal 216 can be made out of Tetrafluoroethylene (TFE) with a stainless steel spring. A first face seal 218 on the piston 106 creates a seal between the piston 106 and the upper portion of the brake body 102 when the piston 106 is disengaged. The piston 106 is disengaged when the piston 106 is not exerting a force against the shaft of the system. A second face seal 220 creates a seal between the piston and the brake plate 202 when the piston 106 is engaged. The piston 106 is engaged when the piston 106 is exerting a force on the shaft of the system. The face seals 218 and 220 can be o-rings made from PTFE. A third face seal 222 can also be used between the brake plate 202 and the upper portion of the brake body 102 to seal the pressure within the brake assembly 100.

FIG. 2B shows a perspective view of the brake piston 106. The piston 106 includes a piston cap 230 which is attached via a pair of screws 232. For example, the screws used can be flat head, hex screws, etc.

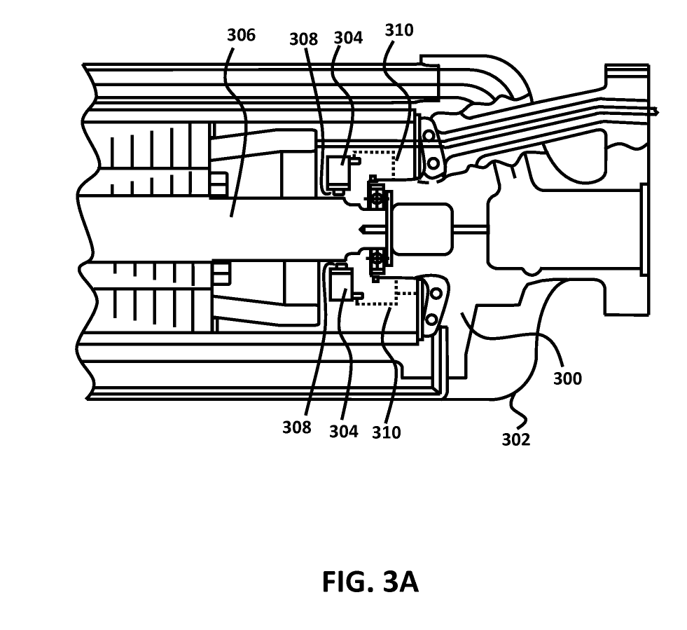

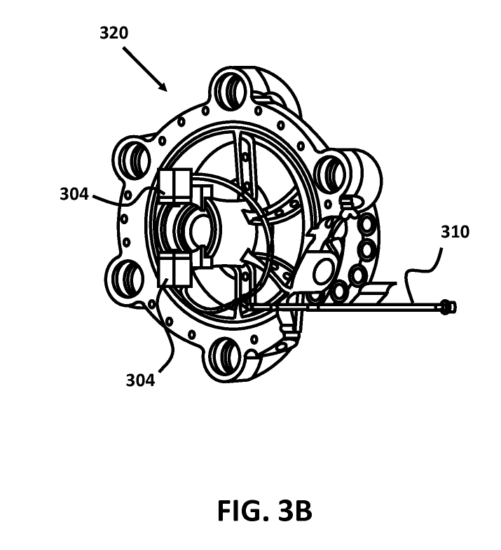

FIG. 3A illustrates a partially broken, cross-sectional view of a pump/expander 300 seated within a vessel 302. Two brakes 304 are positioned opposite of each other across the shaft 306 of the pump/expander 300. The brake pads 308 of the brakes 304 push against the shaft 306 when the pistons (not shown) of the brakes 304 are engaged. Supply lines 310 provide pressurized fluid or gas from a source inside or outside of the vessel through the head plate of the pump/expander 300. The two brakes 304 can be fed via a single supply line 310 which splits to feed each of the brakes 304. Alternatively, each of the brakes 304 can be fed via its own supply line. FIG. 3B illustrates a perspective view of the head plate 320 of the pump/expander 300, with a single, external supply line 310 for supplying pressurized fluid or gas to the brakes 304.

Embodiments are not limited to using only two brakes to support the shaft 306. For example, depending on the size of the shaft and the size of the brakes, more than two brakes may be necessary. It may also be determined that when the vessel is subject to constant and heavy forces, more than two brakes may be necessary to reduce the stress on the bearings. Brakes need not be arranged opposite of each other across the shaft, at angles of approximately 180 degrees from each other. However, it is important for the overall forces applied by the brakes to the shaft be balanced; otherwise additional stress could be introduced to the bearings. For example, if three brakes are used, they should be positioned at angles of approximately 120 degrees from each other so as to balance the forces between the three brakes and steps should be taken to make sure that all three brakes employ and deploy at the same time, such as by using a single feed line with split lines of approximately equal length to each brake so gas or fluid being supplied to one brake does not arrive before gas or fluid supplying other brakes.

If the pump/expander or other structure includes more than one shaft, a set of brakes can be used for each shaft of the pump/expander. For example, an expander may consist of a turbine shaft and an electric motor shaft, with the torque from the turbine shaft transmitted to the electric motor shaft through a magnetic coupling membrane. In such an expander, a first set of brakes can be used to secure the turbine shaft and a second set of brakes can be used to secure the electric motor shaft. The fluid or gas used to feed the hydraulics of the first set of brakes and the second set of brakes can be supplied via a single feed line, with the single feed line first splitting into a first feed line for the first set of brakes and a second feed line for the second set of brakes. The first feed line and the second feed line may subsequently split into two or more feed lines as necessary for each brake within each set of brakes. Alternatively, each set of brakes can have its own independent feed line, which is subsequently split as necessary to feed each brake within each set of brakes. Alternative embodiments may also use the fluid or gas being pumped or expanded to feed the hydraulics of the brake assembly. Since the shaft holding system described herein is used during standstill conditions, the supply line can also extract fluid or gas from the vessel housing the pump/expander.

While a number of embodiments have been illustrated and described herein, along with several alternatives and combinations of various elements, for use in pumps, expanders, or some other form of turbomachine structure, it is to be understood that the embodiments described herein are not limited to only be used with turbomachines and can have a multitude of additional uses and applications. Accordingly, the embodiments should not be limited to just the particular descriptions, variations and drawing figures contained in this specification, which merely illustrate a preferred embodiment and several alternative embodiments.

What is claimed is:

1. A system for holding a shaft of a machine contained within a vessel during standstill conditions, comprising:
two or more brakes arranged around the shaft;
a supply line feeding the two or more brakes with a pressurized fluid or gas, the pressurized fluid or gas increasing a pressure within the two or more brakes and causing the two or more brakes to exert approximately equal forces on the shaft during standstill conditions.

2. The system as recited in claim 1, wherein a first brake among the two or more brakes is positioned approximately 180 degrees opposite a second brake among the two or more brakes.

3. The system as recited in claim 1, wherein each brake from the two or more brakes includes:
a bellows chamber including an inlet, the supply line feeding the pressurized fluid or gas to the bellows chamber through the inlet, the bellows chamber expanding as the pressure within the bellows chamber increases;
a piston adjoining the bellows chamber and moving toward the shaft when the bellows chamber expands and exerts a first force on the piston; and
a brake pad, the piston exerting a second force on the brake pad in response to the first force, and the brake pad exerting a third force on the shaft for holding the shaft.

4. The system as recited in claim 1, wherein the pressurized fluid or gas is extracted from within the vessel.

5. The system as recited in claim 1, wherein the pressurized fluid or gas is a mostly inert gas, wherein the vessel includes a head plate, and wherein the supply line extends through the head plate to supply the mostly inert gas from a source external to the vessel.

6. The system as recited in claim 1, wherein the pressurized fluid or gas is a mostly inert fluid, wherein the vessel includes a head plate, and wherein the supply line extends through the head plate to supply the mostly inert fluid from a source external to the vessel.

7. The system as recited in claim 1, wherein the two or more brakes are arranged around a first portion of the shaft, and wherein an additional two or more brakes are arranged around a second portion of the shaft.

8. The system as recited in claim 1, further comprising a bias spring for exerting a bias pressure opposite the pressure and sufficient to prevent the two or more brakes from exerting force on the shaft when the pressure is decreased.

9. A system for holding a first shaft and a second shaft of a machine contained within a vessel during standstill conditions, comprising:
a first set of brakes arranged around the first shaft;
a second set of brakes arranged around the second shaft;
a first supply line feeding the first set of brakes with a pressurized fluid or gas, the pressurized fluid or gas increasing a pressure within the first set of brakes and causing the first set of brakes to exert a first force on the first shaft during standstill conditions; and
a second supply line feeding the second set of brakes with the pressurized fluid or gas, the pressurized fluid or gas increasing a pressure within the second set of brakes and causing the second set of brakes to exert a second force on the second shaft during standstill conditions.

10. The system as recited in claim 9, wherein each brake from the first set of brakes is positioned relative to the first shaft to apply an approximately equal force on the first shaft as part of the first force.

11. The system as recited in claim 9, wherein each brake from the second set of brakes is positioned relative to the second shaft to apply an approximately equal force on the second shaft as part of the second force.

12. The system as recited in claim 9, wherein each brake from the first set of brakes includes:
a bellows chamber including an inlet, the supply line feeding the pressurized fluid or gas to the bellows chamber through the inlet, the bellows chamber expanding as a bellows pressure within the bellows chamber increases;
a piston adjoining the bellows chamber and moving toward the first shaft when the bellows chamber expands and exerts the bellows pressure on the piston; and
a brake pad exerting a pad force on the brake pad, and the brake pad exerting a shaft force on the first shaft for holding the first shaft.

13. The system as recited in claim 9, wherein each brake from the second set of brakes includes:
a bellows chamber including an inlet, the supply line feeding the pressurized fluid or gas to the bellows chamber through the inlet, the bellows chamber expanding as a bellows pressure within the bellows chamber increases;
a piston adjoining the bellows chamber and moving toward the second shaft when the bellows chamber expands and exerts the bellows pressure on the piston; and
a brake pad exerting a pad force on the brake pad, and the brake pad exerting a shaft force on the second shaft for holding the second shaft.

14. The system as recited in claim 9, wherein the pressurized fluid or gas is extracted from the vessel.

15. The system as recited in claim 9, wherein the first set of brakes are arranged around a first portion of the first shaft and an additional first set of brakes are arranged around a second portion of the first shaft.

16. The system as recited in claim 9, wherein the second set of brakes are arranged around a first portion of the second shaft and an additional second set of brakes are arranged around a second portion of the second shaft.

17. The system as recited in claim 9, further comprising a first bias spring for exerting a first bias pressure opposite the pressure within the first set of brakes and sufficient to prevent the first set of brakes from exerting force on the shaft when the pressure within the first set of brakes is decreased.

18. The system as recited in claim 9, further comprising a second bias spring for exerting a second bias pressure opposite the pressure within the second set of brakes and sufficient to prevent the second set of brakes from exerting force on the shaft when the pressure within the second set of brakes is decreased.
